(19) United States
(12) Patent Application Publication
(10) Pub. No.: US 2026/0056836 A1
(43) Pub. Date: Feb. 26, 2026

(54) DECODERS, DECODING METHODS, MEMORY SYSTEMS, AND MEMORY CONTROLLERS

(71) Applicant: Yangtze Memory Technologies Co., Ltd., Wuhan (CN)

(72) Inventor: Zhiwei Zhuang, Wuhan (CN)

(21) Appl. No.: 19/052,138

(22) Filed: Feb. 12, 2025

(30) Foreign Application Priority Data
Aug. 26, 2024 (CN) 202411179112.8

(51) Int. Cl. G06F 11/10

(52) U.S. Cl. CPC G06F 11/106; G06F 11/104; G06F 11/1068

(57) ABSTRACT

The present disclosure disclose decoders, decoding methods, memory systems, memory controllers and computer readable storage medium. The decoder comprises a first data processing circuit and a second data processing circuit coupled to the first data processing circuit; the first data processing circuit is configured to: perform a current check calculation using a current column of a check matrix and a current sub-matrix of a current flag matrix, and perform a current incremental check calculation on a result of the current check calculation and a previous syndrome to generate a current syndrome; the second data processing circuit is configured to: determine an error symbol in a next data block of the codeword, using one of the current syndrome or a previous syndrome and a next column of the check matrix, based on the current syndrome not satisfying a check condition; wherein the previous syndrome is generated prior to the current syndrome.

### CROSS-REFERENCE TO RELATED APPLICATIONS

This application claims priority to and the benefit of Chinese Patent Application 202411179112.8, filed on Aug. 26, 2024, which is hereby incorporated by reference in its entirety.

### TECHNICAL FIELD

The present disclosure relates generally to the field of memory and, more particularly to, decoders, decoding methods, memory systems, memory controllers, and computer readable storage medium.

### BACKGROUND

A memory controller and one or more memories may be integrated into various types of memory devices, for example, a solid state disk (SSD), a universal flash storage (UFS), and an embedded multimedia card (eMMC), etc. With the increase of memory integration and bit density, the bit error rate of the memory device increases accordingly, and the reliability problem of data becomes more and more significant.

### BRIEF DESCRIPTION OF DRAWINGS

In the drawings, like reference numbers refer to like or similar parts or elements throughout the several drawings unless otherwise specified. These drawings are not necessarily drawn to scale. It should be understood that these drawings depict only some implementations disclosed in accordance with the present disclosure and should not be considered as limiting the scope of the present disclosure.

FIG. 1 is a schematic diagram of an electronic device according to an example of the present disclosure.

FIG. 2A is a schematic diagram of a memory card according to an example of the present disclosure.

FIG. 2B is a schematic diagram of a solid state disk according to an example of the present disclosure.

FIG. 3 is a schematic block diagram of a three-dimensional NAND memory according to an example of the present disclosure.

FIG. 4 is a schematic cross-sectional view of a memory according to an example of the present disclosure.

FIG. 5 is a schematic diagram of a memory comprising a memory cell array and a peripheral circuit according to an example of the present disclosure.

FIG. 6 is a schematic flowchart of an LDPC iterative check according to an example of the present disclosure.

FIG. 7 is a schematic block diagram of a decoder according to an example of the present disclosure.

FIG. 8 is a schematic block diagram of another decoder according to an example of the present disclosure.

FIG. 9 is a schematic flowchart of another LDPC iterative decoding according to an example of the present disclosure.

FIG. 10 is a flowchart of a decoding method according to an example of the present disclosure.

FIG. 11 is a schematic block diagram of a memory system according to an example of the present disclosure.

### DETAILED DESCRIPTION

For ease of understanding of the present disclosure, example implementations disclosed in the present disclosure will be described in more detail below with reference to the accompanying drawings. Although example implementations of the present disclosure are shown in the accompanying drawings, it should be understood that the present disclosure may be implemented in various forms and should not be limited to the example implementations set forth herein. Rather, these implementations are provided so that the present disclosure can be more thoroughly understood and the scope disclosed in the present disclosure can be fully conveyed to those skilled in the art.

In the following description, numerous details are given in order to provide a more thorough understanding of the present disclosure. However, it will be apparent to one skilled in the art that the present disclosure may be practiced without one or more of these details. In some examples, in order to avoid confusion with the present disclosure, some technical features known in the art are not described; that is, not all features of the actual example may be described here, and well-known functions and structures are not described in detail.

In general, the terms may be understood at least in part from the use in the context. For example, depending at least in part on context, the term “one or more” as used herein may be used to describe any feature, structure, or characteristic in a singular sense, or may be used to describe a combination of features, structures, or characteristics in a plural sense. Similarly, terms such as “a” or “the” may likewise be understood to convey singular usage or convey complex usage, depending at least in part on context. In addition, term “based on” may be understood to not necessarily be intended to convey an exclusive set of factors, and may instead allow for the presence of additional factors that are not necessarily explicitly described, again depending at least in part on the context.

Unless otherwise defined, terms used herein is for the purpose of describing a particular example only and is not to be considered as limitation of the present disclosure. As used herein, the singular forms “a”, “an” and “said/the” are intended to comprise the plural forms as well, unless the context clearly dictates otherwise. It should also be understood that the terms “consists of” and/or “comprising”, when used in this description, identify the presence of stated features, integers, steps, operations, elements and/or parts, but do not exclude the presence or addition of one or more other features, integers, steps, operations, elements, parts and/or groups. As used herein, the term “and/or” comprises any and all combinations of the associated listed items.

For a thorough understanding of the present disclosure, detailed operations and detailed structures will be presented in the following description in order to set forth the technical solutions of the present disclosure. Examples of the present disclosure are described in detail below, however, other implementations may be provided in addition to these detailed description.

To enhance the reliability of data, Error Correcting Code (ECC) technology has been used to detect and correct errors during data transmission. ECC usually uses a BCH algorithm and a low density parity check (LDPC) algorithm to encode and decode data, where the LDPC algorithm has a stronger error correction capability than a BCH algorithm. However, the LDPC algorithm is more complex, resulting in longer data decoding time.

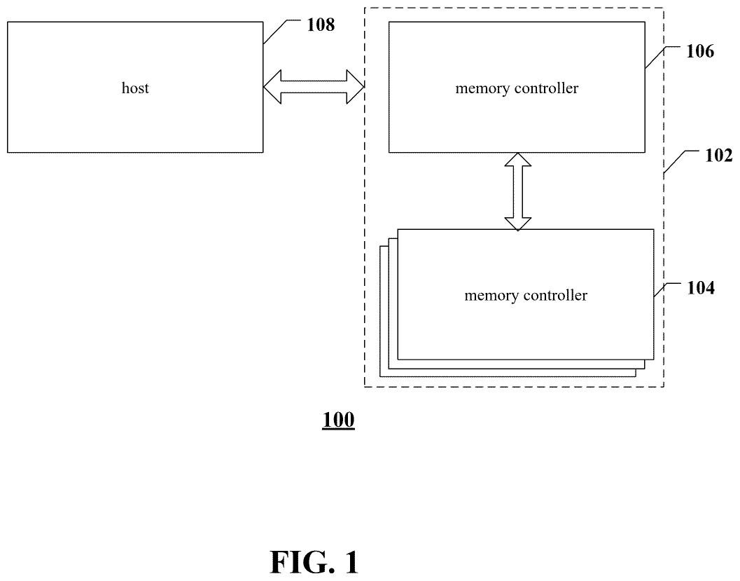

FIG. 1 is a schematic diagram of an electronic device according to an example of the present disclosure. The electronic device 100 may be a mobile phone, a desktop computer, a laptop computer, a tablet, a vehicle computer, a gaming console, a printer, a positioning device, a wearable electronic device, a smart sensor, a Virtual Reality (VR) device, an Augment Reality (AR) device, or any other suitable electronic devices having memory apparatuses therein. Referring to FIG. 1, the electronic device 100 may comprise a host 108 and a memory system 102, and the memory system 102 has one or more memories 104 and a memory controller 106. The host 108 may be a processor of an electronic device (e.g., a Central Processing Unit (CPU)) or a System of Chip (SoC) (e.g., an Application Processor (AP)). The host 108 may be configured to send data to or receive data from the memory 104.

According to some implementations, the memory controller 106 is coupled to the memory 104 and the host 108 and is configured to control memory 104. The memory controller 106 may manage data stored in the memory 104 and communicate with the host 108. In some implementations, the memory controller 106 is designed to operate in low duty cycle environments, e.g., Secure Digital (SD) card, Compact Flash (CF) card, Universal Serial Bus (USB) flash drive, or other media for use in electronic devices such as personal computer, digital camera, mobile phone, etc. In some implementations, the memory controller 106 is designed to operate in high duty cycle environment, such as an SSD or eMMC, and the SSD or eMMC is used as a data memory for mobile devices such as smartphones, tablets, laptops, and enterprise memory arrays.

The memory controller 106 may be configured to control operations of the memory 104, e.g., read, erase and programming operations. The memory controller 106 may also be configured to manage various functions related to data stored or to be stored in the memory 104, comprising but not limited to bad block management, garbage collection, logical-to-physical address translation, wear leveling, etc. In some implementations, the memory controller 106 is also configured to process error correction code related to data read from or written to the memory 104. The memory controller 106 may also perform any other suitable functions, e.g., formatting the memory 104. The memory controller 106 may communicate with external devices (e.g., the host 108 in FIG. 1) according to a particular communication protocol. For example, the memory controller 106 may communicate with external devices through at least one of various interface protocols, such as USB protocol, MMC protocol, Peripheral Component Interconnect (PCI) protocol, Peripheral Component Interconnect Express (PCI-E) protocol, Advanced Technology Attachment (ATA) protocol, Serial ATA protocol, Parallel ATA protocol, Small Computer System Interface (SCSI) protocol, Enhanced Small Disk Interface (ESDI) protocol, Integrated Development Equipment (IDE) protocol, Firewire protocol, etc.

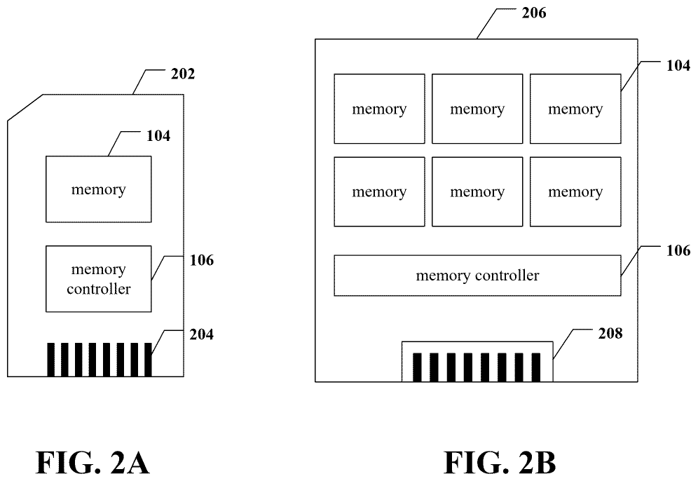

The memory controller 106 and one or more memories 104 may be integrated into various types of memory devices, e.g., comprised in the same package (e.g., UFS package or eMMC package). That is, the memory system 102 may be implemented and packaged into different types of end electronic products. In one example as shown in FIG. 2A, the memory controller 106 and a single memory 104 may be integrated into a memory card 202. The memory card 202 may comprise a Personal Computer Memory Card (PC), a CF card, a Smart Media (SM) card, a memory stick, a Multi-Media Card (MMC), a Reduced-Size MMC (RS-MMC), an MMC micro, an SD card (SD, miniSD, microSD, Reduced-Size MMC (SDHC)), UFS, etc. The memory card 202 may further comprise a memory card connector 24 coupling the memory card 202 with a host (e.g., the host 108 in FIG. 1). In another example as shown in FIG. 2B, the memory controller 106 and multiple memories 104 may be integrated into a SSD 206. The SSD 206 may further comprise an SSD connector 208 coupling the SSD 206 with a host (e.g., the host 108 in FIG. 1). In some implementations, the memory capacity and/or operating speed of the SSD 206 is greater than the memory capacity and/or operating speed of the memory card 202.

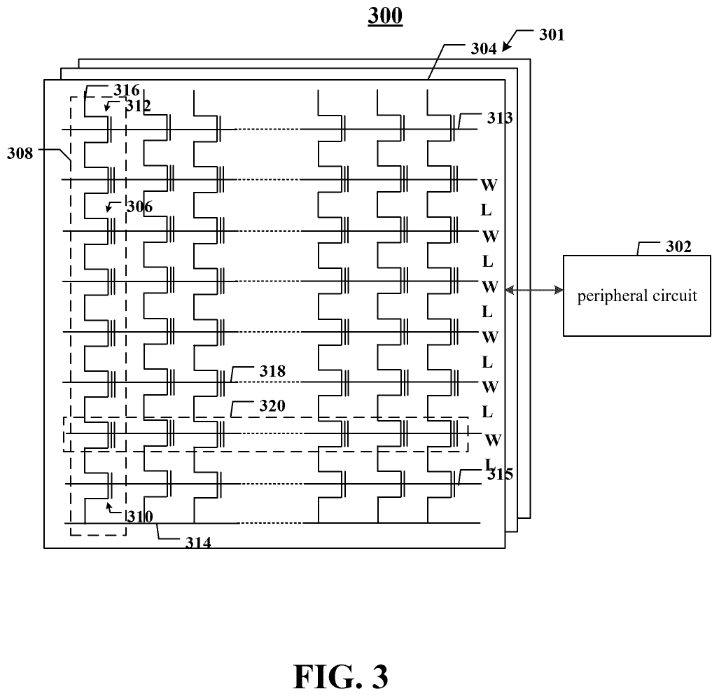

FIG. 3 is a schematic block diagram of a three-dimensional NAND memory according to an example of the present disclosure. The memory 300 may be an example of a memory 104 in FIG. 1. The memory 300 may comprise a memory cell array 301 and a peripheral circuit 302 coupled to the memory cell array 301. Taking the memory cell array 301 being a three-dimensional NAND memory cell array as an example for illustration, where memory cells 306 are provided in the form of an array of NAND memory strings 308, each NAND memory string 308 extends vertically over a substrate (not shown). In some implementations, each NAND memory string 308 comprises multiple memory cells 306 coupled in series and stacked vertically. Each memory cell 306 may retain a continuous analog value, e.g., voltage or charge, depending on the number of electrons trapped within the region of the memory cell 306. Each memory cell 306 may be a floating-gate type memory cell comprising a floating gate transistor, or a charge-trapping type memory cell comprising a charge trapping transistor.

In some implementations, each memory cell 306 is a Single Level Cell (SLC) that has two possible memory states and may thus store one bit of data. For example, a first memory state of “0” may correspond to a first voltage range, and a second memory state of “1” may correspond to a second voltage range. In some implementations, each memory cell 306 is a Multi Level Cell (MLC) capable of storing more than a single bit of data in more than four memory states. For example, an MLC may store two bits per cell, three bits per cell (also known as a Triple Level Cell (TLC)), or four bits per cell (also known as a Quad Level Cell (QLC)). Each MLC can be programmed to assume a range of possible nominal memory values. In one example, if each MLC stores two bits of data, the MLC can be programmed to write one of three possible nominal memory values into the cell, and a fourth nominal memory value other than the three nominal memory values can be used to represent an erase state.

As shown in FIG. 3, each NAND memory string 308 may comprise a bottom select gate (BSG) 310 at its source terminal and a top select gate (TSG) 312 at its drain terminal. BSG 310 and TSG 312 may be configured to activate the selected NAND memory cell string 308 during reading operation and programming operation. In some implementations, the sources of NAND memory strings 308 in the same memory block 304 are coupled through the same source line (SL) 314 (e.g., a common SL). In other words, according to some implementations, all NAND memory strings 308 in the same memory block 304 have an array common source (ACS). According to some implementations, TSG 312 of each NAND memory string 308 is coupled to a corresponding bit line (BL) 316 from which data may be read or written via an output bus (not shown). In some implementations, each NAND memory string 308 is configured to be selected or deselected through applying a select voltage (e.g., above a threshold voltage of a transistor with a TSG 312) or a deselect voltage (e.g., 0V) to a corresponding TSG 312 via one or more TSG lines 313 and/or applying a select voltage (e.g., above a threshold voltage of a transistor with a BSG 310) or a deselect voltage (e.g., 0V) to a corresponding BSG 310 via one or more BSG lines 315.

As shown in FIG. 3, the NAND memory strings 308 may be organized as multiple memory blocks 304, and each of the multiple memory blocks 304 may have a common source line 314 (e.g., coupled to ground). In some implementations, each memory block 304 is a basic data unit for an erase operation, e.g., all memory cells 306 on the same memory block 304 are erased simultaneously. To erase the memory cell 306 in the selected memory block, the source line coupled to the selected memory block and to the unselected memory blocks in the same plane as the selected memory block may be biased with an erase voltage (Vers) (e.g., a high positive voltage (e.g., 20V or higher)). It is should be understood that, in some examples, erase operations may be performed at a half-memory block level, at a quarter-memory block level, or at a level with any suitable number of memory blocks or any suitable fraction of memory blocks. Memory cells 306 of adjacent NAND memory strings 308 may be coupled through a word line 318 that selects which row of memory cells 306 is affected by read and programming operations. In some implementations, memory cells 306 coupled to the same word line 318 in a memory block 304 may constitute at least one physical page 320. Each word line 318 may comprise a plurality of control gates (gate electrodes) at each memory cell 306 of a respective physical page 320 and a gate line coupled to the control gate.

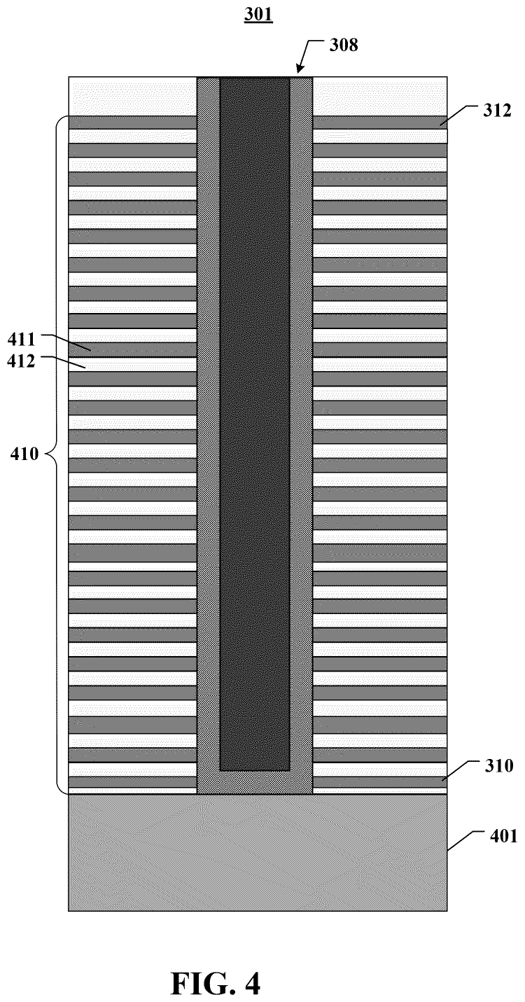

FIG. 4 is a schematic cross-sectional view of a memory according to an example of the present disclosure. Referring to FIG. 4, the NAND memory string 308 may comprise a stacked structure 410 comprising a plurality of gate layers 411 and a plurality of insulating layers 412 stacked alternately in sequence, and a memory string 308 vertically penetrating the gate layers 411 and the insulating layers 412. The gate layers 411 and the insulating layers 412 may be alternately stacked, and two adjacent gate layers 411 are separated by one insulating layer 412. The number of pairs of gate layers 411 and insulating layers 412 in the stacked structure 410 may determine the number of memory cells comprised in the memory cell array 301.

A constituent material of the gate layer 411 may comprise a conductive material. The conductive material comprises, but are not limited to, tungsten (W), cobalt (Co), copper (Cu), aluminum (Al), polysilicon, doped silicon, silicide, or any combination thereof. In some examples, each gate layer 411 comprises a metal layer, e.g., a tungsten layer. In some examples, each gate layer 411 comprises a doped polysilicon layer. Each gate layer 411 may comprise a control gate surrounding a memory cell. A gate layer 411 at the top of a stacked structure 410 may extend laterally as a top select gate line, a gate layer 411 at the bottom of a stacked structure 410 may extend laterally as a bottom select gate line, and a gate layer 411 extending laterally between a top select gate line and a bottom select gate line may serve as a word line layer.

In some examples, the stacked structure 410 may be disposed on a substrate 401. The substrate 401 may comprise silicon (e.g., monocrystalline silicon), silicon germanium (SiGe), gallium arsenide (GaAs), germanium (Ge), silicon-on-insulator (SOI), germanium-on-insulator (GOI), or any other appropriate material.

In some examples, the NAND memory string 308 comprises a channel structure extending vertically through the stacked structure 410. In some implementations, the channel structure comprises a channel hole filled with semiconductor material(s) (e.g., as a semiconductor channel) and dielectric material(s) (e.g., as a memory film). In some implementations, the semiconductor channel comprises silicon, e.g., polysilicon. In some implementations, the memory film is a composite dielectric layer comprising a tunneling layer, a memory layer (also referred to as a “charge-trapping/memory layer”), and a blocking layer. A channel structure may have a cylindrical shape (e.g., a pillar shape). According to some implementations, a semiconductor channel, a tunneling layer, a memory layer and a blocking layer are radially arranged in this order from the center of a pillar toward the outer surface of the pillar. The tunneling layer may comprise silicon oxide, silicon oxynitride, or any combination thereof. The memory layer may comprise silicon nitride, silicon oxynitride, or any combination thereof. The blocking layer may comprise silicon oxide, silicon oxynitride, a high-k (high-k) dielectric, or any combination thereof. In an example, the memory film may comprise a composite layer of silicon oxide/silicon oxynitride/silicon oxide (ONO).

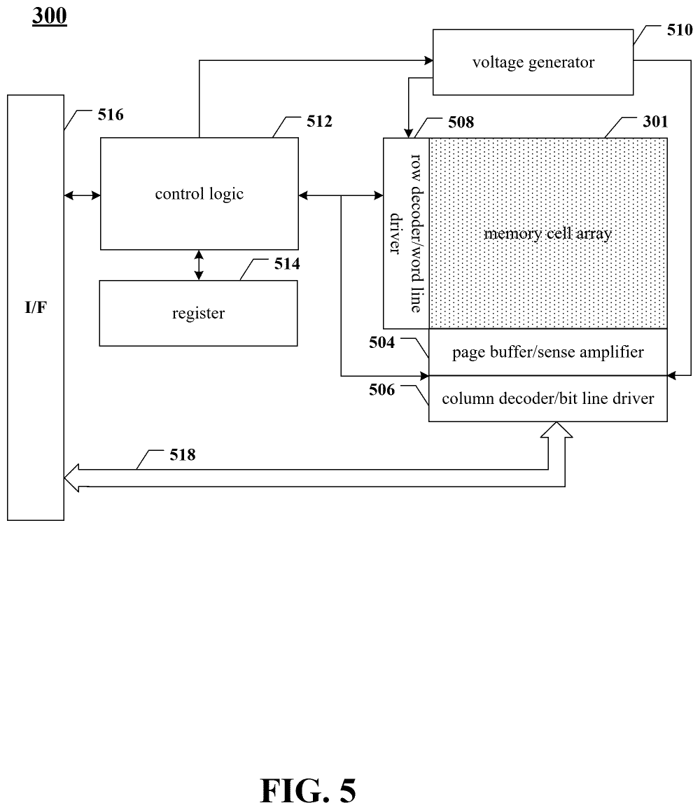

Referring back to FIG. 3, the peripheral circuit 302 may be coupled to the memory cell array 301 through bit lines 316, word lines 318, source lines 314, BSG line 315s, and TSG lines 313. The peripheral circuit 302 may comprise any suitable analog, digital, and mixed-signal circuitry, for facilitating operation of the memory cell array 301 through applying voltage signals and/or current signals to and sensing voltage signals and/or current signals from each target memory cell 306 via bit lines 316, word lines 318, source lines 314, BSG lines 315, and TSG lines 313. The peripheral circuit 302 may comprise various types of peripheral circuits formed with metal-oxide-semiconductor (MOS) technology. For example, FIG. 5 illustrates some example peripheral circuits, the peripheral circuit 302 comprises a page buffer/sense amplifier 504, a column decoder/bit line driver 506, a row decoder/word line driver 508, a voltage generator 510, a control logic 512, a register 514, an interface 516 and data bus 518. It should be understood that in some examples, additional peripheral circuits not shown in FIG. 5 may also be comprised.

The page buffer/sense amplifier 504 may be configured to read data from and program (write) data to the memory cell array 301 according to control signals from the control logic 512. In one example, the page buffer/sense amplifier 504 may store one page of programmed data (written data) to be programmed into one physical page of the memory cell array 301. In another example, the page buffer/sense amplifier 504 may perform a programming verifying operation to ensure that data has been correctly programmed into the memory cell 306 coupled to a selected word line 318. In yet another example, the page buffer/sense amplifier 504 may also sense a low power signal from a bit line 316 representing a data bit stored in the memory cell 306 and amplify a small voltage swing to a recognizable logic level during a reading operation. The column decoder/bit line driver 506 may be configured to be controlled by the control logic 512 and to select one or more NAND memory strings 308 through applying a bit line voltage generated from the voltage generator 510.

The row decoder/word line driver 508 may be configured to be controlled by the control logic 512 and to select/deselect the memory block 304 of the memory cell array 301 and to select/deselect a word line 318 of the memory block 304. The row decoder/word line driver 508 may also be configured to drive a word line 318 with a word line voltage generated from the voltage generator 510. In some implementations, the row decoder/word line driver 508 may also select/deselect and drive the BSG line 315 and the TSG line 313. As described in detail below, the row decoder/word line driver 508 is configured to perform programming operations on the memory cells 306 coupled to a selected word line 318. The voltage generator 510 may be configured to be controlled by the control logic 512, and generate a word line voltage (e.g., a reading voltage, a programming voltage, a pass voltage, a channel boost voltage, a verifying voltage, etc.), a bit line voltage and a source line voltage to be supplied to the memory cell array 301.

The control logic 512 may be coupled to each of the peripheral circuits described above, and configured to control operations of each of the peripheral circuits. The register 514 may be coupled to the control logic 512 and comprise status register, command register and address register for storing status information, command operation codes (OP codes) and command addresses for controlling operations of each of the peripheral circuits. The interface 516 may be coupled to the control logic 512 and act as a control buffer to buffer and relay control commands received from a host (not shown) to control logic 512 and to buffer and relay status information received from the control logic 512 to the host. The interface 516 may also be coupled to the column decoder/bit line driver 506 via the data bus 518 and act as a data I/O interface and a data buffer to buffer and relay data to/from the memory cell array 301.

The three-dimensional NAND memory is used as a storage medium that is more stable than a traditional disk storage manner and faster in data reading and writing, and has been widely used in various memory devices. In order to meet the growing storage requirements, the process size of the three-dimensional NAND memory is continuously reduced, and the types of memory cells are continuously evolving from SLC to MLC, TLC, QLC, which leads to an increase in the bit error rate of data. The traditional BCH algorithm is no longer sufficient to ensure the reliability of data. LDPC algorithm, as an error correction manner with error correction capability approaching the Shannon limit, is gradually replacing BCH as a new generation of error correction coding manner.

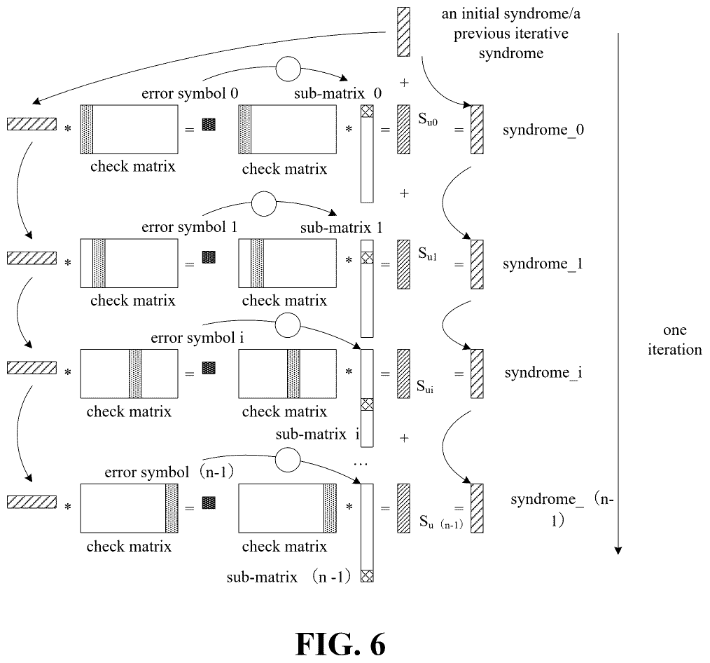

LDPC decoding determines whether to flip a corresponding symbol through the number of errors obtained by multiplying a syndrome and a check matrix. Specifically, an initial check is performed on a codeword by using a check matrix to generate an initial syndrome. If the initial syndrome is 0, the decoding is successful and the decoding is quit; otherwise, the initial syndrome and the check matrix are multiplied to obtain the number of errors, a corresponding symbol is flipped based on the number of errors to obtain the flipped codeword, and at least one iterative check is performed on the flipped codeword until a generated syndrome is 0 or the maximum number of iterations is reached. A codeword typically comprises a plurality of data blocks each comprising a multi-bit symbol. In an iterative check process, the number of errors corresponding to one data block can be obtained by multiplying an initial syndrome or a previous iterative syndrome with one column of a check matrix, and an error symbol corresponding to one data block may be determined based on the number of errors, which is described below with reference to FIG. 6.

FIG. 6 is a schematic flowchart of an LDPC iterative check according to an example of the present disclosure. Referring to FIG. 6, if a previous iterative syndrome (or an initial syndrome) is not 0, the previous iterative syndrome (or the initial syndrome) is multiplied by the first column of a check matrix to obtain the number of errors of the first data block, the error symbol 0 in the first data block is determined based on the number of errors of the first data block, the error symbol 0 is flipped and the first sub-matrix 0 of a current flag matrix is generated, the product S_{U0} of the first column of the check matrix and the first sub-matrix 0 is calculated, and S_{U0} and the previous iterative syndrome (or the initial syndrome) are accumulated to obtain the first syndrome_0.

If the first syndrome_0 is 0, the decoding is successful and the decoding is quit; otherwise, the previous iterative syndrome (or the initial syndrome) is multiplied by the second column of the check matrix to obtain the number of errors of the second data block, the error symbol 1 in the second data block is determined based on the number of errors of the second data block, the error symbol 1 is flipped and the second sub-matrix 1 of the current flag matrix is generated, the product S_{U1} of the second column of the check matrix and the second sub-matrix 1 is calculated, and S_{U1} and the first iterative syndrome_0 are accumulated to obtain the second syndrome_1.

If the second syndrome_1 is 0, the decoding is successful and the decoding is quit; otherwise, a incremental check similar to the first syndrome_0 and the second syndrome_1 is performed until a resulted incremental syndrome is 0 or a current iteration ends. It may be understood that, if the initial syndrome is not 0, the current iterative check may be the first iterative check.

It should be noted that, each sub-matrix in the current flag matrix is used to indicate whether a symbol of a corresponding data block is flipped. For example, the first sub-matrix 0 is used to indicate whether a symbol of the first data block of a codeword is flipped, . . . , and the n-th sub-matrix n−1 is used to indicate whether a symbol of the n-th data block of the codeword is flipped.

FIG. 6 shows that after each incremental calculation, by checking whether a corresponding syndrome is 0 to determine whether decoding is successful, the complexity of LDPC decoding can be reduced to a certain extent, and decoding can be quit in time, especially in a scenario in which a large amount of data needs to be decoded. However, in this solution, during each incremental calculation, the number of errors in each data block of the codeword is calculated by using the syndrome (for example, the initial syndrome or the previous iterative syndrome) generated at the end of a previous iteration, resulting in a long decoding time, especially when the bit error rate of the codeword is low.

Based on one or more of the foregoing technical problems, an example of the present disclosure provides a decoder.

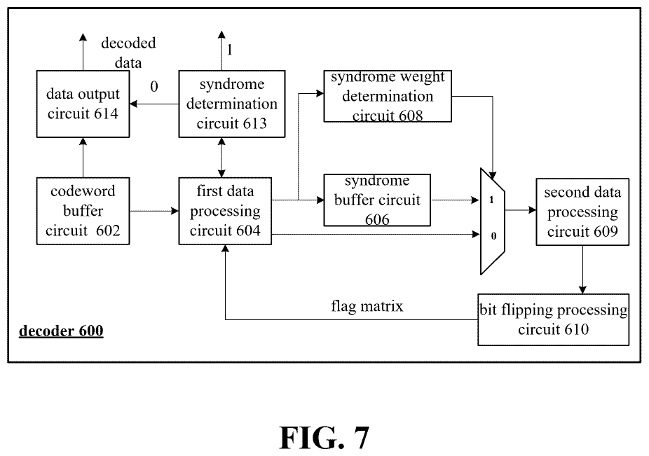

FIG. 7 is a schematic block diagram of a decoder according to an example of the present disclosure. Referring to FIG. 7, the decoder 600 comprises a first data processing circuit 604 and a second data processing circuit 609 coupled to the first data processing circuit 604;
The first data processing circuit 604 is configured to: perform a current check calculation using a current column of a check matrix and a current sub-matrix of a current flag matrix, and perform a current incremental check calculation on a result of the current check calculation and a previous syndrome to generate a current syndrome; wherein the check matrix comprises n columns, and n is an integer greater than 1; the current flag matrix comprises n sub-matrices, and the current sub-matrix is related to a current data block of a flipped codeword; the codeword comprises n data blocks, each of the data blocks comprises k symbols, and k is a positive integer; the current sub-matrix comprises k current flag bits, and each current flag bit is configured to indicate whether a corresponding symbol in a current data block of the codeword is flipped;
The second data processing circuit 609 is configured to: determine an error symbol in a next data block of the codeword, using one of the current syndrome or a previous syndrome and a next column of the check matrix, based on the current syndrome not satisfying a check condition; wherein the previous syndrome is generated prior to the current syndrome.

In examples of the present disclosure, the codeword includes, but is not limited to, a quasi-cyclic (QC) LDPC code. The check matrix of the quasi-cyclic (QC) LDPC code may comprise a plurality of sub-check matrices, each sub-check matrix may be a zero matrix or a cyclic permutation matrix, and the cyclic permutation matrix may be an identity matrix or a sub-check matrix obtained by performing a predetermined number of cyclic shifts on the identity matrix.

For example, the codeword comprises a 512-bit symbol, the codeword may be divided into 4 data blocks, and each data block comprises a 128-bit symbol. Correspondingly, the current sub-matrix may comprise 128 current flag bits, and the 128 current flag bits of the current sub-matrix are respectively configured to indicate whether the 128-bit symbol of a current data block is flipped. For example, if a certain symbol of the current data block is flipped, a current flag bit in a current sub-matrix corresponding to the flipped symbol may be set to a logic value “1”; if other symbols of the current data block do not flip, current flag bits in the current sub-matrix corresponding to the unflipped symbols may be set to a logic value “0”. Here, an example in which a value of n is 4 and a value of k is 128 is used as an example for description, however, it does not constitute a limitation on the protection scope of the present disclosure.

In an example of the present disclosure, if a syndrome is updated in real-time, the second data processing circuit 609 may determine the error symbol in the next data block of the codeword, by using the current syndrome and the next column of the check matrix; and if the updating of the syndrome is delayed, the second data processing circuit 609 may determine the error symbol in the next data block of the codeword, by using the previous syndrome and the next column of the check matrix. That is, the second data processing circuit 609 may determine the error symbol in the next data block based on the latest updated syndrome and the next column of the check matrix. Here, if the update of the syndrome is delayed, the previous syndrome may be a syndrome that is generated before the current syndrome.

It may be understood that a current iterative check comprises at least one incremental check calculation. In an example of the present disclosure, the current check calculation may be performed using the current column of the check matrix and the current sub-matrix of the current flag matrix, and the current incremental check calculation may be performed on the result of the current check calculation and the previous syndrome to generate the current syndrome. If the current syndrome does not satisfy the check condition, the error symbol in the next data block of the codeword is determined using one of the current syndrome or the previous syndrome and the next column of the check matrix. In this way, the latest updated syndrome can be used in the decoding process to calculate the number of errors, reducing the decoding time. Especially when the bit error rate of codeword is low, LDPC decoding can be accelerated.

In some examples, the decoder 600 further comprises a bit flipping processing circuit 610 coupled to the first data processing circuit 604 and the second data processing circuit 609, respectively; and the bit flipping processing circuit 610 is configured to: flip the error symbol in the next data block of the codeword, and generate a next sub-matrix of the current flag matrix, wherein the next sub-matrix comprises k next flag bits, and each of the next flag bits is configured to indicate whether a corresponding symbol in the next data block of the codeword is flipped; and the first data processing circuit 604 is further configured to: perform a next check calculation using a next column of the check matrix and the next sub-matrix, and perform a next incremental check calculation on a result of the next check calculation and the current syndrome to generate a next syndrome.

In examples of the present disclosure, when determining the error symbol in the next data block of the codeword, the bit flipping processing circuit 610 may flip the error symbol in the next data block of the codeword, and generate the next sub-matrix of the current flag matrix. For example, the next data block comprises a 128-bit symbol, and the next sub-matrix may comprise 128 next flag bits. If a certain symbol of the next data block is flipped, the next flag bit in the next sub-matrix corresponding to the flipped symbol may be set to a logic value “1”; if other symbols of the next data block are not flipped, current flag bits in the next sub-matrix corresponding to the unflipped symbols may be set to a logic value “0”.

In examples of the present disclosure, the first data processing circuit 604 may perform the next check calculation using the next column of the check matrix and the next sub-matrix, and perform the next incremental check calculation on the result of the next check calculation and the current syndrome to generate the next syndrome. If the next syndrome satisfies the check condition, it indicates that the decoding is successful, and the flipped codeword is output. In this way, the decoding can be quit in time, the decoding time is reduced, and excessive error flipping is avoided.

In some examples, the decoder 600 further comprises a data output circuit 614 coupled to the first data processing circuit 604, and the data output circuit 614 is configured to: output the flipped codeword based on the next syndrome satisfying the check condition.

It should be noted that, the current incremental check calculation and the next incremental check calculation belong to different stages of the current iterative check. When a syndrome generated by an initial iterative check does not satisfy the check condition, at least one codeword may be flipped and at least one iterative check may be performed correspondingly. The flag matrix associated with the flipped codeword may be generated each time the flipped codeword enters an iterative check, and at least one incremental check calculation is performed using at least one column of the check matrix and at least one sub-matrix of the flag matrix to obtain at least one incremental syndrome. When the incremental syndrome satisfies the check condition, the decoding is quit in time, so that the decoding time is reduced, and incorrect flipping caused by a redundant incremental check calculation is avoided. For example, each iteration in the related solution needs to perform n incremental check calculations to determine whether the decoding is successful, the time consumed on decoding is long, and there may be redundancy of incremental check calculations.

In examples of the present disclosure, the check condition comprises a syndrome being 0. The check condition is satisfied, that is, a calculated initial syndrome or incremental syndrome is 0; and the check condition is not satisfied, that is, the calculated initial syndrome or incremental syndrome is not 0. The following describes an example in which the check condition is that the syndrome is equal to 0, and the initial syndrome will be described in detail in the following examples, and details are not described herein again.

In some examples, the next syndrome is the n-th syndrome; and the second data processing circuit 609 is further configured to: determine an error symbol of the current data block of the codeword, using a previous syndrome generated in a previous check calculation and the current column of the check matrix in each check calculation process of a next iterative check, based on the next syndrome not satisfying the check condition and a weight of the next syndrome being less than or equal to a first preset threshold.

A weight of the syndrome (also referred to as the Hamming weight) may be used to characterize the number of symbols in the codeword that do not satisfy the check equation. Generally, as iterative decoding continues, the weight of the syndrome gradually decreases. When the weight of the syndrome generated at the end of the current iterative check is less than or equal to a certain preset threshold, indicating that the bit error rate of the current codeword is lower, then in each check calculation process of the next iterative check, the latest updated syndrome may be used to calculate the number of errors; when the weight of the syndrome generated at the end of the current iterative check is greater than a certain preset threshold, indicating that the bit error rate of the current codeword is higher, then in each check calculation process of the next iterative check, the syndrome generated at the end of the current iterative check is used to calculate the number of errors.

In an example of the present disclosure, if the next syndrome is the n-th syndrome and the n-th syndrome is not 0, it indicates that the current iterative check fails, the codeword needs to be flipped again, and the next iterative check is performed on the codeword that is flipped again. At the beginning of the next iterative check, based on whether a weight of the n-th syndrome is less than or equal to the first preset threshold, whether to calculate the number of errors using the previous syndrome generated in the previous check calculation and the current column of the check matrix in each check calculation process of the next iterative check may be firstly determined.

In examples of the present disclosure, if the weight of the n-th syndrome is less than or equal to the first preset threshold, the error symbol of the current data block of the codeword is determined, using the previous syndrome generated in the first check calculation and the current column of the check matrix, in each check calculation process of the next iterative check. Therefore, when the bit error rate of the codeword is lower, the latest updated syndrome is used to calculate the number of errors of the next data block each time, LDPC decoding can be accelerated, and decoding time is greatly reduced. Here, the previous syndrome generated in the first check calculation may be the latest updated syndrome, and the first preset threshold may be set reasonably according to actual conditions, which is not particularly limited in examples of the present disclosure.

For example, the weight of the n-th syndrome is less than or equal to the first preset threshold, and the second data processing circuit 609 may determine the error symbol in the first data block of the codeword, using the n-th syndrome and the first column of the check matrix; the bit flipping processing circuit 610 may flip the error symbol in the first data block of the codeword, and generate the first sub-matrix of the next flag matrix; the first data processing circuit 604 may perform the first check calculation using the first column of the check matrix and the first sub-matrix of the next flag matrix, and perform the first incremental check calculation on the result of the first check calculation and the n-th syndrome to generate the first syndrome of the next iterative check. If the first syndrome of the next iterative check is 0, the decoding is quit; otherwise, the second data processing circuit 609 determines the error symbol in the second data block of the codeword, using one of the first syndrome of the next iterative check or the n-th syndrome of the current iterative check and the second column of the check matrix. That is, in each check calculation process of the next iterative check, the error symbol of the current data block of the codeword is determined, using the previous syndrome generated in the previous check calculation and the current column of the check matrix. Here, if the first syndrome of the next iterative check is updated in real-time, the first syndrome of the next iterative check is used to calculate the number of errors in the second data block of the codeword.

In some examples, the next syndrome is the n-th syndrome; and the second data processing circuit 609 is further configured to: determine an error symbol of the current data block of the codeword, using the next syndrome and the current column of the check matrix in each check calculation process of the next iterative check, based on the next syndrome not satisfying the check condition and the weight of the next syndrome being greater than the first preset threshold.

In examples of the present disclosure, if the weight of the n-th syndrome is greater than the first preset threshold, the error symbol of the current data block of the codeword is determined, using the next syndrome and the current column of the check matrix, in each check calculation process of the next iterative check. In this way, when the bit error rate of the codeword is higher, the number of errors of each data block is calculated each time using the syndrome updated after a previous iteration, thereby reducing decoding time and avoiding incorrect flipping of symbols.

For example, the weight of the n-th syndrome is greater than the first preset threshold, and the second data processing circuit 609 may determine the error symbol in the first data block of the codeword, using the n-th syndrome and the first column of the check matrix; the bit flipping processing circuit 610 may flip the error symbol in the first data block of the codeword, and generate the first sub-matrix of the next flag matrix; the first data processing circuit 604 may perform the first check calculation using the first column of the check matrix and the first sub-matrix of the next flag matrix, and perform the first incremental check calculation on the result of the first check calculation and the n-th syndrome to generate the first syndrome of the next iterative check. If the first syndrome of the next iterative check is 0, the decoding is quit; otherwise, the second data processing circuit 609 continues to use the n-th syndrome and the second column of the check matrix to determine the error symbol in the second data block of the codeword. That is, in each check calculation process of the next iterative check, the n-th syndrome of the current iterative check and the current column of the check matrix are used to determine the error symbol of the current data block of the codeword.

In some examples, the decoder 600 further comprises a syndrome weight determination circuit 608 coupled to the first data processing circuit 604 and the second data processing circuit 609, respectively; and the syndrome weight determination circuit 608 is configured to determine whether the weight of the next syndrome is less than or equal to the first preset threshold.

In examples of the present disclosure, the syndrome weight determination circuit 608 may generate the first determination result based on the weight of the next syndrome being less than or equal to the first preset threshold; the second data processing circuit 609 determines the error symbol of the current data block of the codeword, using the previous syndrome generated in the previous check calculation and the current column of the check matrix in each check calculation process of the next iterative check, based on the first determination result; the syndrome weight determination circuit 608 may further generate a second determination result, based on the weight of the next syndrome being greater than the first preset threshold; and the second data processing circuit 609 determines the error symbol of the current data block of the codeword, using the next syndrome and the current column of the check matrix in each check calculation process of the next iterative check, based on the second determination result.

It may be understood that, the syndrome weight determination circuit 608 may determine whether the weight of the syndrome generated at the end of an initial check or the end of each iterative check is less than or equal to a certain preset threshold, after the initial check ends or after each iterative check ends, and generate a corresponding determination result; and the second data processing circuit 609 performs different strategies for calculating the number of errors in each check calculation process of a next iterative check based on the determination result generated by the syndrome weight determination circuit 608.

In some examples, the bit flipping processing circuit 610 is configured to: set a next flag bit in a next sub-matrix of the current flag matrix corresponding to an error symbol in a next data block of the codeword to a flag logic value, based on the error symbol being flipped.

For example, the next data block comprises a 128-bit symbol, and the next sub-matrix may comprise 128 next flag bits. If a certain symbol of the next data block is flipped, the bit flipping processing circuit 610 sets the corresponding next flag bit in the next sub-matrix to the logic value “1” according to the position of the flipped error symbol, and the logic value “1” is configured to indicate that the error symbol is flipped.

It should be noted that, the number of the sub-matrices in the current flag matrix may be the same as the number of data blocks in the codeword, that is, the current flag matrix comprises n sub-matrices, and the number of flag bits in each sub-matrix may be the same as the number of symbols in each data block, that is, each sub-matrix comprises k flag bits. In some examples, in the case where the codeword is not flipped, each sub-matrix of the current flag matrix may be an all-zero matrix, and a flag bit in the current flag matrix corresponding to the unflipped symbol is a logic value “0”.

In examples of the present disclosure, by setting the next flag bit in the next sub-matrix of the current flag matrix corresponding to the error symbol to the flag logic value, the corresponding next sub-matrix is generated, and the check calculation is performed by using the next column of the check matrix and the next sub-matrix. Since the number of bits of the symbols flipped in the codeword is usually much smaller than the number of bits of unflipped symbols in the codeword, in each sub-matrix of the flag matrix, the number of logic values “1” is small and the number of logic values “0” is large, so that the complexity of iterative check calculations can be simplified and decoding process can be accelerated, thereby reducing decoding time.

In some examples, the first data processing circuit 604 is further configured to: perform an initial check on the codeword using the check matrix to generate an initial syndrome; the second data processing circuit 609 is further configured to: determine an error symbol of a current data block of the codeword, using a previous syndrome generated in a previous check calculation and the current column of the check matrix in each check calculation process of a first iterative check or in each check calculation process of each of multiple iterative checks, based on the initial syndrome not satisfying the check condition and a weight of the initial syndrome being less than or equal to a second preset threshold.

In examples of the present disclosure, in the initial check process, a conventional calculation manner may be used. For example, S=HC^{T}, S represents an initial syndrome, H represents a check matrix, and C represents a codeword. If the initial syndrome S is 0, the decoding is successful. If the initial syndrome S is not 0, at least one iterative check is performed. It can be understood that, the initial check generates one initial syndrome, and the iterative check can generate at least one incremental syndrome, and the calculation manner of the initial syndrome and the calculation manner of the at least one incremental syndrome generated by each iterative check are different.

In examples of the present disclosure, if the initial syndrome is not 0, it indicates that the initial check fails, the codeword needs to be flipped, and at least one iterative check is performed on the flipped codeword. At the beginning of entering the iterative check, whether to calculate the number of errors using a previous syndrome generated in a previous check calculation and the current column of the check matrix in each check calculation process of a first iterative check or in each check calculation process of each of multiple iterative checks may be firstly selected, based on whether the weight of the initial syndrome is less than or equal to a second preset threshold. Herein, the second preset threshold may be set reasonably according to actual conditions, and the second preset threshold and the first preset threshold may be the same or different, which is not specifically limited in examples of the present disclosure.

For example, the weight of the initial syndrome is less than or equal to the second preset threshold, and the second data processing circuit 609 may calculate the number of errors of the next data block, using the latest updated syndrome in each check calculation process of the first iterative check. It may be understood that, if the weight of the initial syndrome is less than or equal to the second preset threshold, then it indicates that the bit error rate of the original to-be-decoded codeword is low. Therefore, the number of errors of the next data block can be calculated using the latest updated syndrome, LDPC decoding can be accelerated, and decoding time is greatly reduced.

For example, the weight of the initial syndrome is less than or equal to the second preset threshold, and the second data processing circuit 609 may calculate the number of errors of the next data block, using the latest updated syndrome in each check calculation process of each of the multiple iterative checks. That is, in the process of performing the multiple iterative checks, the syndrome determination circuit 613 only needs to determine whether the weight of the initial syndrome is less than or equal to the second preset threshold, and does not need to determine a weight of a syndrome after other iterative checks end. In this way, the number of times to determine syndromes can be reduced, LDPC decoding is accelerated, decoding time is further shortened, and the overhead of software and/or hardware resources is reduced.

In some examples, the second data processing circuit 609 is further configured to: determine the error symbol of the current data block of the codeword, using the initial syndrome and the current column of the check matrix in each check calculation process of the first iterative check, based on the initial syndrome not satisfying the check condition and the weight of the initial syndrome being greater than the second preset threshold.

In examples of the present disclosure, if the weight of the initial syndrome is greater than the second preset threshold, the second data processing circuit 609 may determine the error symbol of the current data block of the codeword, using the initial syndrome and the current column of the check matrix in each check calculation process of the first iterative check. It may be understood that, if the weight of the initial syndrome is greater than the second preset threshold, then it indicates that the bit error rate of the original to-be-decoded codeword is high. Therefore, in a case where the bit error rate of the codeword is high, each check calculation process of the first iterative check uses the initial syndrome to calculate the number of errors of each data block, thereby reducing decoding time and avoiding incorrect flipping of symbols.

In some examples, the second data processing circuit 609 is further configured to: determine an error symbol of a current data block of the codeword using a syndrome generated at the end of a previous iterative check and the current column of the check matrix in each check calculation process of each of multiple iterative checks after the first iterative check, based on a weight of the initial syndrome being greater than the second preset threshold and a syndrome generated at the end of the first iterative check not satisfying the check condition.

In examples of the present disclosure, if the syndrome generated at the end of the first iterative check does not satisfy the check condition, it indicates that the first iterative check fails. Since the weight of the initial syndrome is greater than the second preset threshold, indicating that the bit error rate of the original to-be-decoded codeword is high, the second data processing circuit 609 may determine the error symbol of the current data block of the codeword, using the syndrome generated at the end of the previous iterative check and the current column of the check matrix in each check calculation process of each of the multiple iterative checks after the first iterative check. For example, in each check calculation process of the second iterative check, the error symbol of the current data block of the codeword is determined using the syndrome generated at the end of the first iterative check and the current column of the check matrix.

In some examples, the decoder 600 further comprises a syndrome buffer circuit 606 coupled to the first data processing circuit 604 and the second data processing circuit 609, respectively, and the syndrome buffer circuit 606 is configured to: buffer the initial syndrome or a syndrome generated at the end of each iterative check.

In some examples, the first data processing circuit 604 is configured to: calculate a product of the current column of the check matrix and the current sub-matrix of the current flag matrix to generate a current sub-syndrome; and perform an XOR operation on the previous syndrome and the current sub-syndrome to generate the current syndrome.

In examples of the present disclosure, the first data processing circuit 604 may comprise a matrix multiplier and a matrix adder, where the matrix multiplier is configured to calculate a product of a current column of the check matrix and a current sub-matrix of the current flag matrix, which is implemented by an AND operation and an XOR operation; and the matrix adder is configured to calculate a sum of a previous syndrome and a current sub-syndrome, which is implemented by an XOR operation.

In some examples, the decoder 600 further comprises a codeword buffer circuit 602 coupled to the first data processing circuit 604, and the codeword buffer circuit 602 is configured to buffer the codeword or the flipped codeword. For example, in the case where the original to-be-decoded codeword is input to the decoder 600, the codeword buffer circuit 602 may buffer the input original to-be-decoded codeword (e.g., the codeword). For another example, in a case where the initial check fails or an iterative check fails, the codeword buffer circuit 602 may buffer the iterative decoded codeword (e.g., the flipped codeword). The first data processing circuit 604 may obtain an input original to-be-decoded codeword from the codeword buffer circuit 602 to perform an initial check, or obtain an iterative decoded codeword from the codeword buffer circuit 602 to perform a next iterative check.

In some examples, the decoder 600 further comprises a syndrome determination circuit 613 coupled to the first data processing circuit 604 and the data output circuit 614, respectively, and the syndrome determination circuit 613 is configured to: determine whether the current syndrome satisfies the check condition.

In examples of the present disclosure, the syndrome determination circuit 613 may receive the current syndrome generated by the first data processing circuit 604. If the current syndrome is 0, the syndrome determination circuit 613 generates a third determination result, and the data output circuit 614 outputs the flipped codeword buffered in the codeword buffer circuit 602 based on the third determination result; if the current syndrome is not 0, the syndrome determination circuit 613 generates a fourth determination result, and the first data processing circuit 604 performs the next check calculation and the next incremental check calculation based on the fourth determination result. In FIG. 7, the logic value “0” represents the third determination result, and the logic value “1” represents the fourth determination result. Of course, the syndrome determination circuit 613 may be further configured to determine whether the initial syndrome or other incremental syndromes (e.g., the next syndrome) are 0.

It should be noted that, if the initial syndrome is not 0 or the n-th syndrome of each iterative check is not 0, the bit flipping processing circuit 610 flips the codeword based on the fourth determination result.

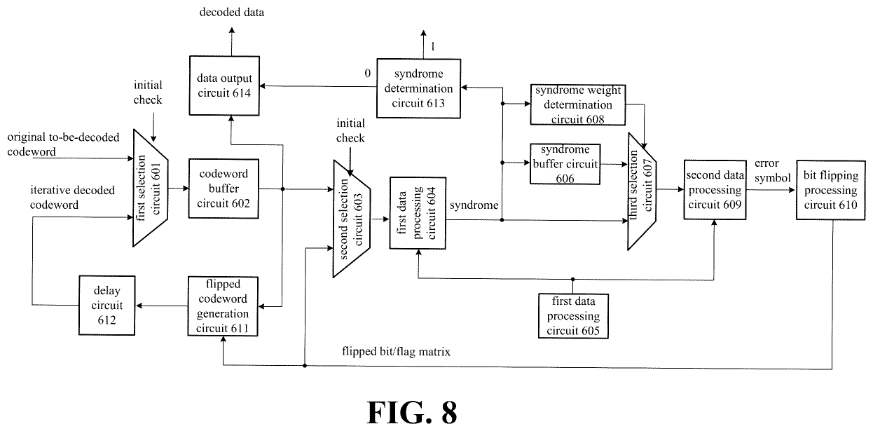

FIG. 8 is a schematic block diagram of another decoder according to an example of the present disclosure. In addition to the codeword buffer circuit 602, the first data processing circuit 604, the syndrome buffer circuit 606, the syndrome weight determination circuit 608, the second data processing circuit 609, the bit flipping processing circuit 610, the syndrome determination circuit 613 and the data output circuit 614 shown in FIG. 7, the decoder 600 may further comprise a first selection circuit 601, a second selection circuit 603, a matrix buffer circuit 605, a third selection circuit 607, a flipped codeword generation circuit 611, and a delay circuit 612. Of course, the decoder 600 may also comprise other circuits known in the art.

The first selection circuit 601 is configured to: output the original to-be-decoded codeword or an iterative decoded codeword, based on a first control signal. For example, if the first control signal indicates that a current check is an initial check, the first selection circuit 601 outputs the original to-be-decoded codeword; and if the first control signal indicates that the current check is an iterative check, the first selection circuit 601 outputs an iterative decoded codeword. It may be understood that, the iterative decoded codeword is different from the original to-be-decoded codeword, and the iterative decoded codeword may be a flipped codeword that is flipped at least once on the basis of the original to-be-decoded codeword. The first selection circuit 601 includes, but is not limited to, a multiplexer.

The codeword buffer circuit 602 is coupled to the first selection circuit 601, and the codeword buffer circuit 602 is configured to: buffer the original to-be-decoded codeword or an iterative decoded codeword. That is, the codeword output by the first selection circuit 601 may be buffered in the codeword buffer circuit 602.

The second selection circuit 603 is coupled to the codeword buffer circuit 602 and the bit flipping processing circuit 610, respectively, and the second selection circuit 603 is configured to: output the original to-be-decoded codeword or a current sub-matrix of a current flag matrix, based on a second control signal. For example, if the second control signal indicates that the current check is the initial check, the second selection circuit 603 outputs the original to-be-decoded codeword; and if the second control signal indicates that the current check is a current iterative check, the second selection circuit 603 outputs the current sub-matrix of the current flag matrix. The second selection circuit 603 includes, but is not limited to, a multiplexer. The following describes an example in which the second selection circuit 603 outputs the current sub-matrix of the current flag matrix as an example.

The first data processing circuit 604 is coupled to the second selection circuit 603 and the matrix buffer circuit 605, respectively, and the first data processing circuit 604 is configured to: perform a current check calculation using a current column of a check matrix and the current sub-matrix of the current flag matrix, and perform a current incremental check calculation on the result of the current check calculation and a previous syndrome to generate a current syndrome. The check matrix may be buffered in the matrix buffer circuit 605, and each time the incremental check calculation needs to be performed, the first data processing circuit 604 may obtain one column of the check matrix from the matrix buffer circuit 605. Of course, in the process of the initial check, the first data processing circuit 604 may obtain the entire check matrix from the matrix buffer circuit 605, that is, obtain the n columns of the check matrix.

The syndrome determination circuit 613 is coupled to the first data processing circuit 604, the data output circuit 614 and the bit flipping processing circuit 610, respectively, and the syndrome determination circuit 613 is configured to: determine whether the current syndrome is 0. If the current syndrome is 0, the data output circuit 614 outputs the iterative decoded codeword buffered in the codeword buffer circuit 602, that is, quits decoding; otherwise, the first data processing circuit 604 performs a next check calculation and a next incremental check calculation to generate a next syndrome. And so on, until an obtained incremental syndrome is 0 or a current iteration ends.

The syndrome buffer circuit 606 is coupled to the first data processing circuit 604, and the syndrome buffer circuit 606 is configured to: buffer an initial syndrome or a syndrome generated at the end of each iterative check, that is, the n-th syndrome generated at the end of each iterative check.

The syndrome weight determination circuit 608 is coupled to the first data processing circuit 604, and the syndrome weight determination circuit 608 is configured to: determine whether a weight of the initial syndrome is less than or equal to a second preset threshold. Of course, when the bit error rate of the codeword is high, the syndrome weight determination circuit 608 is further configured to: determine whether a weight of a syndrome generated at the end of each iteration is less than or equal to a first preset threshold. Here, the first preset threshold and the second preset threshold may be set reasonably according to actual conditions, and the first preset threshold and the second preset threshold may be the same or different, which is not specifically limited in examples of the present disclosure.

The third selection circuit 607 is coupled to the first data processing circuit 604, the syndrome buffer circuit 606 and the syndrome weight determination circuit 608, respectively, and the third selection circuit 607 is configured to: based on determination result generated by the syndrome weight determination circuit 608, output a syndrome generated by the first data processing circuit 604 or a syndrome buffered by the syndrome buffer circuit 606. For example, a weight of a syndrome generated at the end of a previous iteration is less than or equal to the first preset threshold, and in the process of the current iterative check, the third selection circuit 607 outputs a syndrome generated by the first data processing circuit 604 in real-time; the weight of the syndrome generated at the end of the previous iteration is greater than the first preset threshold, and in the process of the current iterative check, the third selection circuit 607 always outputs the syndrome buffered by the syndrome buffer circuit 606. The third selection circuit 607 includes, but is not limited to, a multiplexer.

The second data processing circuit 609 is coupled to the third selection circuit 607 and the matrix buffer circuit 605, respectively, and the second data processing circuit 609 is configured to: determine an error symbol in a next data block of the codeword using the syndrome output by the third selection circuit 607 and the next column of check matrix.

The bit flipping processing circuit 610 is coupled to the second data processing circuit 609, and the bit flipping processing circuit 610 is configured to: flip the error symbol in the next data block of the codeword, and generate a next sub-matrix of the current flag matrix. Of course, the bit flipping processing circuit 610 is further configured to: flip an error symbol in a first data block of the codeword based on the initial syndrome not satisfying a check condition, and generate a first sub-matrix of a first flag matrix.

The flipped codeword generation circuit 611 is coupled to the codeword buffer circuit 602 and the bit flipping processing circuit 610, respectively, and the flipped codeword generation circuit 611 is configured to: generate a next iterative decoded codeword, based on the flipped error symbol and the codeword buffered in the codeword buffer circuit 602. In an example, the flipped codeword generation circuit 611 includes, but is not limited to, an exclusive OR logic gate circuit.

The delay circuit 612 is coupled to the flipped codeword generation circuit 611 and the first selection circuit 601, respectively, and the delay circuit 612 is configured to: delay the next iterative decoded codeword by a preset duration. It should be noted that, the calculation time of the first data processing circuit 604 and the syndrome determination circuit 613 is longer, and if the next iterative decoded codeword is immediately input into the first selection circuit 601, redundant data will be written back to the codeword buffer circuit 602, which may result in an undesirable decoding error. Therefore, the writing-back of the data can be avoided by delaying the next iterative decoded codeword by the preset duration. Here, the preset duration may be set reasonably according to the calculation delay of the data processing circuit, which is not particularly limited in the present disclosure.

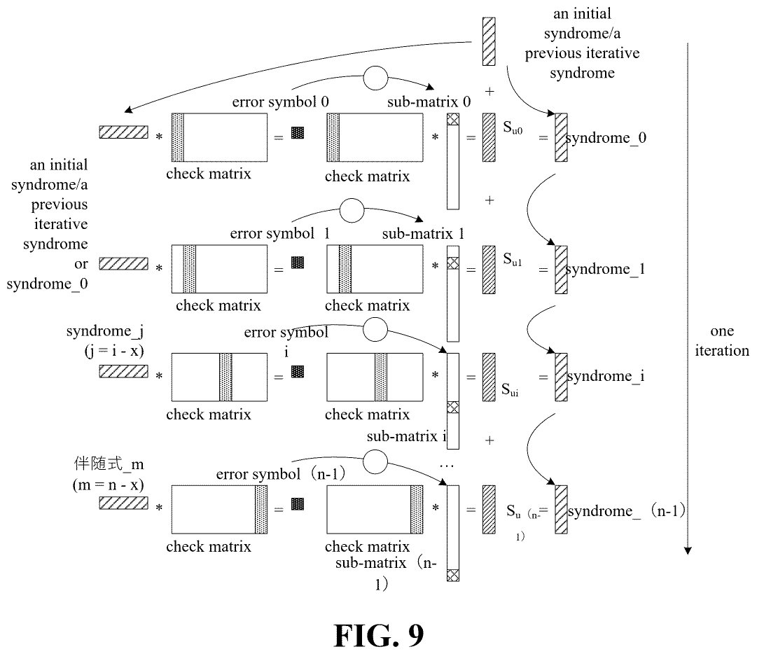

FIG. 9 is a schematic flowchart of another LDPC iterative decoding according to an example of the present disclosure. In the following, an example in which a weight of a previous iterative syndrome is less than or equal to a first preset threshold (or a weight of an initial syndrome is less than or equal to a second preset threshold) is taken as an example, and an example process of performing an iteration by the decoder provided by the example of the present disclosure is described in conjunction with FIG. 9.

In the process of an iteration, an error symbol 0 in a first data block is determined, using the previous iterative syndrome (or the initial syndrome) and a first column of a check matrix; the error symbol 0 is flipped and a first sub-matrix 0 of a current flag matrix is generated; a first check calculation is performed by using the first column of the check matrix and the first sub-matrix 0 of the current flag matrix to generate a first sub-syndrome S_{U0}, and a first incremental check calculation is performed on the first sub-syndrome S_{U0} and the previous iterative syndrome (or the initial syndrome) to generate a first syndrome_0; it is determined whether the first syndrome_0 is 0; if the first syndrome_0 is 0, decoding is successful, and the decoding is quit.

If the first syndrome_0 is not 0, an error symbol 1 in a second data block is determined by using one of the previous iterative syndrome (or the initial syndrome) and the first syndrome_0 and a second column of the check matrix; the error symbol 1 is flipped and a second sub-matrix 1 of the current flag matrix is generated; a second check calculation is performed using the second column of the check matrix and the second sub-matrix 1 of the current flag matrix to generate a second sub-syndrome S_{U1}, and a second incremental check calculation is performed on the second sub-syndrome S_{U1} and the first syndrome_0 to generate the second syndrome_1; it is determined whether the second syndrome_1 is 0; if the second syndrome_1 is 0, decoding is successful, and the decoding is quit. And so on, until an obtained incremental syndrome is 0 (for example, the (i+1)-th syndrome), or the n-th syndrome is still not 0 at the end of a current iteration, a flipped codeword enters a next iteration. Here, if the first syndrome_0 is updated in real-time, the first syndrome_0 and the second column of the check matrix are used to determine the error symbol 1 in the second data block.

It should be noted that, x in FIG. 9 represents a delay period, x is an integer greater than or equal to 1, where x being equal to 1 indicates that there is no delay in the updating of the syndrome, and a previous syndrome (that is, the syndrome i−1) may be put into a calculation of an number of errors of a current data block, so as to determine an error symbol of the current data block; and x being greater than 1 indicates that there is a delay in the updating of the syndrome, and the syndrome that is generated before the previous syndrome may be put into a calculation of an number of errors of the current data block, so as to determine an error symbol of the current data block.

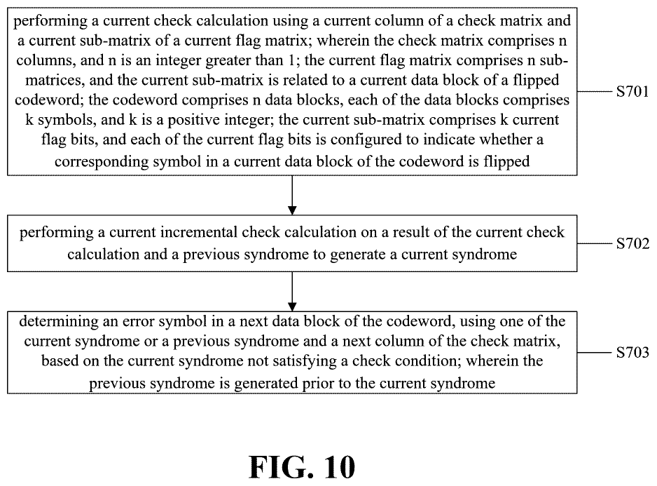

Based on the above decoder, an example of the present disclosure provides a decoding method. FIG. 10 is a flowchart of a decoding method according to an example of the present disclosure. Referring to FIG. 10, the decoding method comprises:
S701: performing a current check calculation using a current column of a check matrix and a current sub-matrix of a current flag matrix; wherein the check matrix comprises n columns, and n is an integer greater than 1; the current flag matrix comprises n sub-matrices, and the current sub-matrix is related to a current data block of a flipped codeword; the codeword comprises n data blocks, each of the data blocks comprises k symbols, and k is a positive integer; the current sub-matrix comprises k current flag bits, and each of the current flag bits is configured to indicate whether a corresponding symbol in a current data block of the codeword is flipped;
S702: performing a current incremental check calculation on a result of the current check calculation and a previous syndrome to generate a current syndrome;
S703: determining an error symbol in a next data block of the codeword, using one of the current syndrome or a previous syndrome and a next column of the check matrix, based on the current syndrome not satisfying a check condition; wherein the previous syndrome is generated prior to the current syndrome.

In some examples, the decoding method further comprises: flipping the error symbol in the next data block of the codeword, and generate a next sub-matrix of the current flag matrix, wherein the next sub-matrix comprises k next flag bits, and each of the next flag bits is configured to indicate whether a corresponding symbol in the next data block of the codeword is flipped; performing a next check calculation using a next column of the check matrix and the next sub-matrix, and perform a next incremental check calculation on a result of the next check calculation and the current syndrome to generate a next syndrome.

In some examples, the next syndrome is an n-th syndrome; and the decoding method further comprises: determining an error symbol of the current data block of the codeword using a previous syndrome generated in a previous check calculation and the current column of the check matrix in each check calculation process of a next iterative check, based on the next syndrome not satisfying the check condition and a weight of the next syndrome being less than or equal to a first preset threshold.

In some examples, the next syndrome is an n-th syndrome; and the decoding method further comprises: determining an error symbol of the current data block of the codeword, using the next syndrome and the current column of the check matrix in each check calculation process of the next iterative check, based on the next syndrome not satisfying the check condition and a weight of the next syndrome being greater than a first preset threshold.

In some examples, the decoding method further comprises: determining whether the weight of the next syndrome is less than or equal to the first preset threshold.

In some examples, the generating the next sub-matrix of the current flag matrix comprises: setting a next flag bit in a next sub-matrix of the current flag matrix corresponding to an error symbol in a next data block of the codeword to a flag logic value, based on the error symbol being flipped.

In some examples, the decoding method further comprise: outputting the flipped codeword, based on the next syndrome satisfying the check condition.

In some examples, the decoding method further comprises: performing an initial check on the codeword using the check matrix to generate an initial syndrome; and determining an error symbol of a current data block of the codeword, using a previous syndrome generated in a previous check calculation and the current column of the check matrix in each check calculation process of a first iterative check or in each check calculation process of each of multiple iterative checks, based on the initial syndrome not satisfying the check condition and a weight of the initial syndrome being less than or equal to a second preset threshold.

In some examples, the decoding method further comprises: performing an initial check on the codeword using the check matrix to generate an initial syndrome; and determining an error symbol of a current data block of the codeword, using the initial syndrome and the current column of the check matrix in each check calculation process of a first iterative check, based on the initial syndrome not satisfying the check condition and a weight of the initial syndrome being greater than a second preset threshold.

In some examples, the decoding method further comprises: determining an error symbol of a current data block of the codeword, using a syndrome generated at the end of a previous iterative check and the current column of the check matrix in each check calculation process of each of multiple iterative checks after the first iterative check, based on the weight of the initial syndrome being greater than the second preset threshold and the syndrome generated at the end of the first iterative check not satisfying the check condition.

In some examples, the decoding method further comprises: buffering the initial syndrome or the syndrome generated at the end of each iterative check.

In some examples, S701 comprises: calculating a product of the current column of the check matrix and the current sub-matrix of the current flag matrix to generate a current sub-syndrome; and S702 comprises: performing an XOR operation on the previous syndrome and the current sub-syndrome to generate the current syndrome.

In some examples, the check condition comprises a syndrome being 0.

In examples of the present disclosure, the decoding method may be performed by the decoder in any one of the foregoing examples, and technical effects that can be achieved by the decoder in the foregoing examples can also be achieved by the decoding method, and details are not described herein again. Regarding the decoding method in the above examples, the specific implementations of each operation have been described in detail in the relevant decoder examples, and will not be described in detail here.

Based on the above decoder, an example of the present disclosure further provides a memory system. The memory system comprises a memory and a decoder coupled to the memory. The memory is configured to output read data; the decoder is configured to perform a decoding operation on the codeword obtained by converting the read data.

In some examples, the memory system further comprises an encoder configured to: receive the written data and perform an encoding operation on the written data; and the memory is further configured to receive the encoded written data.

Based on the above decoder, an example of the present disclosure further provides a memory controller, comprising:
a memory interface configured to receive read data;
a decoder coupled to the memory interface and configured to perform a decoding operation on the codeword obtained by converting the read data.

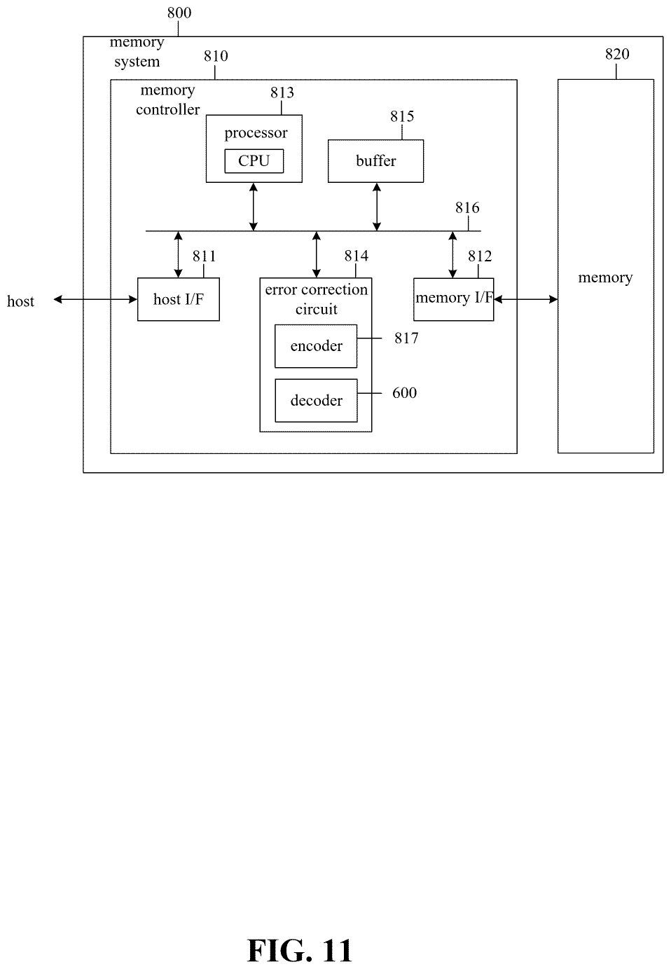

FIG. 11 is a schematic block diagram of a memory system according to an example of the present disclosure. The memory system and the memory controller provided in examples of the present disclosure will be described below with reference to FIG. 11.

Referring to FIG. 11, the memory system 800 comprises a memory controller 810 and a memory 820, the memory controller 810 is configured to control the memory 820 to perform a read/write operation. Here, the memory controller 810 and the memory 820 may be coupled in any suitable manner. The memory controller 810 comprises a processor (CPU) 813, a buffer 815, an error correction circuit 814, a host I/F 811, a memory I/F 812. In examples of the present disclosure, the memory 820 may be a semiconductor memory that stores data in a non-volatile manner, for example, a NAND type memory. The memory system 800 is connected to a host. The host I/F 811 outputs commands, valid data (written data), and the like received from the host to the internal bus 816, and sends valid data (read data) read from the memory 820, a response from the processor 813, and the like to the host.

The processor 813 may instruct the memory I/F 812 to write the valid data and the parity data and the check matrix to the memory 820 according to commands from the host, and the control part may instruct the memory I/F 812 to read the valid data and the parity data and the check matrix from the memory according to commands from the host.

The error correction circuit 814 herein comprises an encoder 817 and the above decoder 600, the encoder 817 encodes valid data of a predetermined size written to generate parity data (for example, a low density parity check code LDPC) and a corresponding check matrix, the parity data generated by the encoder 817 and the corresponding check matrix may be stored in the memory, and the above decoder 600 uses the parity data and the corresponding check matrix to decode. The decoder 600 herein comprises a coder, and the parity code and the corresponding check matrix during coding may be obtained from the memory.

Based on the above decoder, an example of the present disclosure further provides a computer-readable storage medium, wherein the computer-readable storage medium stores an instruction thereon, and the instruction is executed by the processor to implement the decoding method according to any one of the foregoing examples.

Herein, all or part of the processes in the decoding method in the foregoing examples may be implemented by instructing related hardware by using instructions, and the instructions may be stored in a computer-readable storage medium, and when the instructions are executed, the flow of examples of the foregoing methods may be comprised. The storage medium may be a magnetic random access memory (FRAM), a read only memory (ROM), a programmable read-only memory (PROM), an erasable programmable read-only memory (EPROM), an electrically erasable programmable read-only memory (EEPROM), a flash memory, a magnetic surface memory, an optical disk, a compact disc read-only memory (CD-ROM), and the like; and the storage medium may further comprise a combination of the foregoing types of memories.

The features disclosed in the several apparatus examples provided by the present disclosure may be arbitrarily combined without conflict to obtain a new apparatus example.

The method disclosed in the several method examples provided by the present disclosure may be arbitrarily combined without conflict to obtain a new method example.

It should be understood that “one example” or “an example” mentioned throughout the specification means that a specific feature, structure, or characteristic related to the example is included in at least one example of the present disclosure. Thus, “in one example” or “in an example” appearing throughout the specification need not necessarily refer to the same example. Further, these particular features, structures, or characteristics may be incorporated in one or more examples in any suitable manner. It should be understood that, in various examples of the present disclosure, the sequence numbers of the foregoing processes do not mean a sequence of execution sequences, and an execution sequence of each process should be determined by function and intrinsic logic thereof, and should not constitute any limitation on an implementation process of examples of the present disclosure. The foregoing sequence numbers of examples of the present disclosure are merely for description, and do not represent the advantages or disadvantages of examples.

It should be noted that, in this specification, the terms “comprising”, “including”, or any other variant thereof are intended to cover a non-exclusive inclusion, such that a process, method, article, or apparatus that comprises a series of elements comprises not only those elements but also other elements not explicitly listed, or elements inherent to such processes, methods, articles, or apparatuses. Without further restriction, the elements defined by the statement “comprise one . . . ” do not preclude the presence of additional identical elements in the process, method, article, or apparatus that comprises the element.

According to a first aspect of examples of the present disclosure, a decoder is provided, comprising: a first data processing circuit and a second data processing circuit coupled to the first data processing circuit; the first data processing circuit is configured to: perform a current check calculation using a current column of a check matrix and a current sub-matrix of a current flag matrix, and perform a current incremental check calculation on a result of the current check calculation and a previous syndrome to generate a current syndrome; wherein the check matrix comprises n columns, and n is an integer greater than 1; the current flag matrix comprises n sub-matrices, and the current sub-matrix is related to a current data block of a flipped codeword; the codeword comprises n data blocks, each of the data blocks comprises k symbols, and k is a positive integer; the current sub-matrix comprises k current flag bits, and each current flag bit is configured to indicate whether a corresponding symbol in a current data block of the codeword is flipped; and the second data processing circuit is configured to: determine an error symbol in a next data block of the codeword using one of the current syndrome or a previous syndrome and a next column of the check matrix, based on the current syndrome not satisfying a check condition; wherein the previous syndrome is generated prior to the current syndrome.

In some examples, the decoder further comprises a bit flipping processing circuit coupled to the first data processing circuit and the second data processing circuit, respectively; the bit flipping processing circuit is configured to: flip the error symbol in the next data block of the codeword, and generate a next sub-matrix of the current flag matrix, wherein the next sub-matrix comprises k next flag bits, and each of the next flag bits is configured to indicate whether a corresponding symbol in the next data block of the codeword is flipped; the first data processing circuit is further configured to: perform a next check calculation using a next column of the check matrix and the next sub-matrix, and perform a next incremental check calculation on a result of the next check calculation and the current syndrome to generate a next syndrome.

In some examples, the next syndrome is an n-th syndrome; and the second data processing circuit is further configured to: determine an error symbol of the current data block of the codeword, using a previous syndrome generated in a previous check calculation and the current column of the check matrix in each check calculation process of a next iterative check, based on the next syndrome not satisfying the check condition and a weight of the next syndrome being less than or equal to a first preset threshold.

In some examples, the next syndrome is an n-th syndrome; and the second data processing circuit is further configured to: determine an error symbol of the current data block of the codeword, using the next syndrome and the current column of the check matrix in each check calculation process of the next iterative check, based on the next syndrome not satisfying the check condition and the weight of the next syndrome being greater than the first preset threshold.

In some examples, the decoder further comprises a syndrome weight determination circuit coupled to the first data processing circuit and the second data processing circuit, respectively; and the syndrome weight determination circuit is configured to: determine whether the weight of the next syndrome is less than or equal to the first preset threshold.

In some examples, the bit flipping processing circuit is configured to:
set a next flag bit in a next sub-matrix of the current flag matrix corresponding to an error symbol in a next data block of the codeword to a flag logic value, based on the error symbol being flipped.

In some examples, the decoder further comprises a data output circuit coupled to the first data processing circuit, and the data output circuit is configured to: output the flipped codeword, based on the next syndrome satisfying the check condition.

In some examples, the first data processing circuit is further configured to: perform an initial check on the codeword using the check matrix to generate an initial syndrome; the second data processing circuit is further configured to: determine an error symbol of a current data block of the codeword, using a previous syndrome generated in a previous check calculation and the current column of the check matrix in each check calculation process of a first iterative check or in each check calculation process of each of multiple iterative checks, based on the initial syndrome not satisfying the check condition and a weight of the initial syndrome being less than or equal to a second preset threshold.

In some examples, the first data processing circuit is further configured to: perform an initial check on the codeword using the check matrix to generate an initial syndrome; the second data processing circuit is further configured to: determine an error symbol of a current data block of the codeword, using the initial syndrome and the current column of the check matrix in each check calculation process of the first iterative check, based on the initial syndrome not satisfying the check condition and the weight of the initial syndrome being greater than the second preset threshold.

In some examples, the second data processing circuit is further configured to: determine an error symbol of a current data block of the codeword, using a syndrome generated at the end of a previous iterative check and the current column of the check matrix in each check calculation process of each of multiple iterative checks after the first iterative check, based on the weight of the initial syndrome being greater than the second preset threshold and the syndrome generated at the end of the first iterative check not satisfying the check condition.

In some examples, the decoder further comprises a syndrome buffer circuit coupled to the first data processing circuit and the second data processing circuit, respectively, and the syndrome buffer circuit is configured to: buffer the initial syndrome or the syndrome generated at the end of each iterative check.

In some examples, the first data processing circuit is configured to: calculate a product of the current column of the check matrix and the current sub-matrix of the current flag matrix to generate a current sub-syndrome; and perform an XOR operation on the previous syndrome and the current sub-syndrome to generate the current syndrome.

In some examples, the check condition comprises a syndrome being 0.

According to a second aspect of examples of the present disclosure, a decoding method is provided, comprising: performing a current check calculation using a current column of a check matrix and a current sub-matrix of a current flag matrix; wherein the check matrix comprises n columns, and n is an integer greater than 1; the current flag matrix comprises n sub-matrices, and the current sub-matrix is related to a current data block of a flipped codeword; the codeword comprises n data blocks, each of the data blocks comprises k symbols, and k is a positive integer; the current sub-matrix comprises k current flag bits, and each current flag bit is configured to indicate whether a corresponding symbol in a current data block of the codeword is flipped; performing a current incremental check calculation on a result of the current check calculation and a previous syndrome to generate a current syndrome; and determining an error symbol in a next data block of the codeword, using one of the current syndrome or a previous syndrome and a next column of the check matrix, based on the current syndrome not satisfying a check condition; wherein the previous syndrome is generated prior to the current syndrome.

In some examples, the decoding method further comprises: flipping an error symbol in a next data block of the codeword, and generating a next sub-matrix of the current flag matrix, wherein the next sub-matrix comprises k next flag bits, and each of the next flag bits is configured to indicate whether a corresponding symbol in a next data block of the codeword is flipped; performing a next check calculation using a next column of the check matrix and the next sub-matrix, and performing a next incremental check calculation on a result of the next check calculation and the current syndrome to generate a next syndrome.

In some examples, the next syndrome is an n-th syndrome; and the decoding method further comprises: determining an error symbol of a current data block of the codeword, using a previous syndrome generated in a previous check calculation and the current column of the check matrix in each check calculation process of a next iterative check, based on the next syndrome not satisfying the check condition and a weight of the next syndrome being less than or equal to a first preset threshold.

In some examples, the next syndrome is an n-th syndrome; and the decoding method further comprises: determining an error symbol of a current data block of the codeword, using the next syndrome and the current column of the check matrix in each check calculation process of the next iterative check, based on the next syndrome not satisfying the check condition and a weight of the next syndrome being greater than a first preset threshold.

In some examples, the decoding method further comprises: determining whether a weight of the next syndrome is less than or equal to the first preset threshold.

In some examples, the generating a next sub-matrix of the current flag matrix comprises: setting a next flag bit in a next sub-matrix of the current flag matrix corresponding to an error symbol in a next data block of the codeword to a flag logic value, based on the error symbol being flipped.

In some examples, the decoding method further comprise: outputting the flipped codeword, based on the next syndrome satisfying the check condition.

In some examples, the decoding method further comprises: performing an initial check on the codeword using the check matrix to generate an initial syndrome; and determining an error symbol of a current data block of the codeword, using a previous syndrome generated in a previous check calculation and the current column of the check matrix in each check calculation process of a first iterative check or in each check calculation process of each of multiple iterative checks, based on the initial syndrome not satisfying the check condition and a weight of the initial syndrome being less than or equal to a second preset threshold.

In some examples, the decoding method further comprises: performing an initial check on the codeword using the check matrix to generate an initial syndrome; and determining an error symbol of a current data block of the codeword, using the initial syndrome and the current column of the check matrix in each check calculation process of the first iterative check, based on the initial syndrome not satisfying the check condition and a weight of the initial syndrome being greater than the second preset threshold.

In some examples, the decoding method further comprises: determining an error symbol of a current data block of the codeword, using a syndrome generated at the end of a previous iterative check and the current column of the check matrix in each check calculation process of each of multiple iterative checks after the first iterative check, based on a weight of the initial syndrome being greater than the second preset threshold and a syndrome generated at the end of the first iterative check not satisfying the check condition.

In some examples, the decoding method further comprises: buffering the initial syndrome or a syndrome generated at the end of each iterative check.

In some examples, the performing a current check calculation using the current column of the check matrix and the current sub-matrix of the current flag matrix comprises: calculating a product of the current column of the check matrix and the current sub-matrix of the current flag matrix to generate a current sub-syndrome;
the performing a current incremental check calculation on a result of the current check calculation and a previous syndrome to generate the current syndrome comprises: performing an XOR operation on the previous syndrome and the current sub-syndrome to generate the current syndrome.

In some examples, the check condition comprises a syndrome being 0.

According to a third aspect of examples of the present disclosure, a memory system is provided, comprising: a memory configured to output read data;

the decoder according to any of examples of the first aspect of the present disclosure, wherein the decoder is coupled to the memory; and the decoder is configured to: perform a decoding operation on a codeword obtained by converting the read data.

In some examples, the memory system further comprises: an encoder configured to receive written data and perform an encoding operation on the written data; the memory is further configured to: receive the encoded written data.

According to a fourth aspect of examples of the present disclosure, a memory controller is provided, comprising: a memory interface configured to receive read data; the decoder according to any of examples of the first aspect of the present disclosure, wherein the decoder is coupled to the memory interface; and the decoder is configured to: perform a decoding operation on a codeword obtained by converting the read data.

According to a fifth aspect of examples of the present disclosure, a computer-readable storage medium storing instructions thereon is provided, the instructions are executed by a processor to implement the decoding method according to any of examples of the second aspect of the present disclosure.

In examples of the present disclosure, a current check calculation may be performed using a current column of the check matrix and a current sub-matrix of the current flag matrix, and a current incremental check calculation may be performed on a result of a current check calculation and a previous syndrome to generate a current syndrome. If a current syndrome does not satisfy a check condition, an error symbol in a next data block of a codeword is determined using one of a current syndrome or a previous syndrome and a next column of a check matrix. In this way, the latest updated syndrome can be used in a decoding process to calculate the number of errors, reducing decoding time. Especially when the bit error rate of a codeword is low, LDPC decoding can be accelerated.

The above description is only an example of the present disclosure, but the protection scope of the present disclosure is not limited thereto, and changes or replacements that may be easily conceived by any person skilled in the art within the technical scope of the present disclosure should be covered within the protection scope of the present disclosure.

What is claimed is:

1. A decoder, comprising:
a first data processing circuit; and
a second data processing circuit coupled to the first data processing circuit;
the first data processing circuit is configured to: perform a current check calculation using a current column of a check matrix and a current sub-matrix of a current flag matrix, and perform a current incremental check calculation on a result of the current check calculation and a previous syndrome to generate a current syndrome; wherein the check matrix includes n columns, and n is an integer greater than 1; the current flag matrix includes n sub-matrices, and the current sub-matrix is related to a current data block of a flipped codeword; the codeword includes n data blocks, each of the data blocks includes k symbols, and k is a positive integer; the current sub-matrix includes k current flag bits, and each of the current flag bits is configured to indicate whether a corresponding symbol in a current data block of the codeword is flipped; and
the second data processing circuit is configured to: determine an error symbol in a next data block of the codeword, using one of the current syndrome or a previous syndrome and a next column of the check matrix, based on the current syndrome not satisfying a check condition; wherein the previous syndrome is generated prior to the current syndrome.

2. The decoder of claim 1, further including:
a bit flipping processing circuit coupled to the first data processing circuit and the second data processing circuit, respectively; the bit flipping processing circuit is configured to:
flip the error symbol in the next data block of the codeword, and generate a next sub-matrix of the current flag matrix, wherein the next sub-matrix includes k next flag bits, and each of the next flag bits is configured to indicate whether a corresponding symbol in the next data block of the codeword is flipped;
the first data processing circuit is further configured to:
perform a next check calculation using a next column of the check matrix and the next sub-matrix, and perform a next incremental check calculation on a result of the next check calculation and the current syndrome to generate a next syndrome.

3. The decoder of claim 2, wherein the next syndrome is an n-th syndrome; and the second data processing circuit is further configured to:
determine an error symbol of the current data block of the codeword, using a previous syndrome generated in a previous check calculation and the current column of the check matrix in each check calculation process of a next iterative check, based on the next syndrome not satisfying the check condition and a weight of the next syndrome being less than or equal to a first preset threshold.

4. The decoder of claim 2, wherein the next syndrome is an n-th syndrome; and the second data processing circuit is further configured to:
determine an error symbol of the current data block of the codeword, using the next syndrome and the current column of the check matrix in each check calculation process of the next iterative check, based on the next syndrome not satisfying the check condition and a weight of the next syndrome being greater than a first preset threshold.

5. The decoder of claim 3, further including:
a syndrome weight determination circuit coupled to the first data processing circuit and the second data processing circuit, respectively; and the syndrome weight determination circuit is configured to:
determine whether the weight of the next syndrome is less than or equal to the first preset threshold.

6. The decoder of claim 2, wherein the bit flipping processing circuit is configured to:
set a next flag bit in a next sub-matrix of the current flag matrix corresponding to an error symbol in a next data block of the codeword to a flag logic value, based on the error symbol being flipped.

7. The decoder of claim 2, further including:
a data output circuit coupled to the first data processing circuit, and the data output circuit is configured to:
output the flipped codeword, based on the next syndrome satisfying the check condition.

8. The decoder of claim 1, wherein the first data processing circuit is further configured to: perform an initial check on the codeword using the check matrix to generate an initial syndrome;
the second data processing circuit is further configured to:
determine an error symbol of a current data block of the codeword, using a previous syndrome generated in a previous check calculation and the current column of the check matrix in each check calculation process of a first iterative check or in each check calculation process of each of multiple iterative checks, based on the initial syndrome not satisfying the check condition and a weight of the initial syndrome being less than or equal to a second preset threshold.

9. The decoder of claim 1, wherein the first data processing circuit is further configured to: perform an initial check on the codeword using the check matrix to generate an initial syndrome;
the second data processing circuit is further configured to:
determine an error symbol of a current data block of the codeword, using the initial syndrome and the current column of the check matrix in each check calculation process of a first iterative check, based on the initial syndrome not satisfying the check condition and a weight of the initial syndrome being greater than a second preset threshold.

10. The decoder of claim 9, wherein the second data processing circuit is further configured to:
determine an error symbol of a current data block of the codeword, using a syndrome generated at the end of a previous iterative check and the current column of the check matrix in each check calculation process of each of multiple iterative checks after the first iterative check, based on the weight of the initial syndrome being greater than the second preset threshold and the syndrome generated at the end of the first iterative check not satisfying the check condition.

11. The decoder of claim 8, further including:
a syndrome buffer circuit coupled to the first data processing circuit and the second data processing circuit, respectively, and the syndrome buffer circuit is configured to:
buffer the initial syndrome or the syndrome generated at the end of each iterative check.

12. The decoder of claim 1, wherein the first data processing circuit is configured to:
calculate a product of the current column of the check matrix and the current sub-matrix of the current flag matrix to generate a current sub-syndrome; and
perform an XOR operation on the previous syndrome and the current sub-syndrome to generate the current syndrome.

13. The decoder of claim 1, wherein the check condition includes a syndrome being 0.

14. A decoding method, comprising:
performing a current check calculation using a current column of a check matrix and a current sub-matrix of a current flag matrix; wherein the check matrix includes n columns, and n is an integer greater than 1; the current flag matrix includes n sub-matrices, and the current sub-matrix is related to a current data block of a flipped codeword; the codeword includes n data blocks, each of the data blocks includes k symbols, and k is a positive integer; the current sub-matrix includes k current flag bits, and each of the current flag bits is configured to indicate whether a corresponding symbol in a current data block of the codeword is flipped;
performing a current incremental check calculation on a result of the current check calculation and a previous syndrome to generate a current syndrome; and
determining an error symbol in a next data block of the codeword, using one of the current syndrome or a previous syndrome and a next column of the check matrix, based on the current syndrome not satisfying a check condition; wherein the previous syndrome is generated prior to the current syndrome.

15. The decoding method of claim 14, further including:
flipping the error symbol in the next data block of the codeword, and generating a next sub-matrix of the current flag matrix, wherein the next sub-matrix includes k next flag bits, and each of the next flag bits is configured to indicate whether a corresponding symbol in the next data block of the codeword is flipped; and
performing a next check calculation using a next column of the check matrix and the next sub-matrix, and perform a next incremental check calculation on a result of the next check calculation and the current syndrome to generate a next syndrome.

16. The decoding method of claim 15, wherein the next syndrome is an n-th syndrome; and the decoding method further including:
determining an error symbol of the current data block of the codeword, using a previous syndrome generated in a previous check calculation and the current column of the check matrix in each check calculation process of a next iterative check, based on the next syndrome not satisfying the check condition and a weight of the next syndrome being less than or equal to a first preset threshold.

17. The decoding method of claim 15, wherein the next syndrome is an n-th syndrome; and the decoding method further including:
determining an error symbol of the current data block of the codeword, using the next syndrome and the current column of the check matrix in each check calculation process of the next iterative check, based on the next syndrome not satisfying the check condition and a weight of the next syndrome being greater than a first preset threshold.

18. The decoding method of claim 16, further including:
determining whether the weight of the next syndrome is less than or equal to the first preset threshold.

19. The decoding method of claim 15, wherein the generating the next sub-matrix of the current flag matrix includes:
set a next flag bit in a next sub-matrix of the current flag matrix corresponding to an error symbol in a next data block of the codeword to a flag logic value, based on the error symbol being flipped.

20. A memory controller, comprising:
a memory interface configured to receive read data; and
a decoder including:
a first data processing circuit; and
a second data processing circuit coupled to the first data processing circuit;
the first data processing circuit is configured to: perform a current check calculation using a current column of a check matrix and a current sub-matrix of a current flag matrix, and perform a current incremental check calculation on a result of the current check calculation and a previous syndrome to generate a current syndrome; wherein the check matrix includes n columns, and n is an integer greater than 1; the current flag matrix includes n sub-matrices, and the current sub-matrix is related to a current data block of a flipped codeword; the codeword includes n data blocks, each of the data blocks includes k symbols, and k is a positive integer; the current sub-matrix includes k current flag bits, and each of the current flag bits is configured to indicate whether a corresponding symbol in a current data block of the codeword is flipped; and
the second data processing circuit is configured to: determine an error symbol in a next data block of the codeword, using one of the current syndrome or a previous syndrome and a next column of the check matrix, based on the current syndrome not satisfying a check condition; wherein the previous syndrome is generated prior to the current syndrome,
wherein the decoder is coupled to the memory interface; and the decoder is configured to: perform a decoding operation on a codeword obtained by converting the read data.
